(19) United States
(12) Patent Application Publication
(10) Pub. No.: US 2006/0109413 A1
(43) Pub. Date: May 25, 2006

(54) Sealant pattern for flat display panel

(76) Inventor: Sun-Youl Lee, Suwon-si (KR)

Correspondence Address: Robert E. Bushnell, Suite 300, 1522 K Street, N.W., Washington, DC, 20005-1202, US

(21) Appl. No.: 11/280,302

(22) Filed: Nov. 17, 2005

(30) Foreign Application Priority Data
Nov. 22, 2004 (KR) 10-2004-0095942

(51) Int. Cl. G02F 1/1339

(52) U.S. Cl. 349/153

(57) ABSTRACT

A sealant pattern for sealing a sealing member adapted to seal a light emitting diode formed on a substrate, and a flat display device having the sealant pattern includes: a substrate having an image display unit on which display devices are arranged; and a sealing member for sealing the substrate using a sealant. The sealant includes a main pattern formed to surround the image display unit and protrusion patterns protruding from the main pattern at the corners of the substrate. The main pattern of the sealant includes a frame pattern that surrounds the image display unit along the edges of the substrate. The protrusion parts of the sealant include at least one bar or block pattern protruding from the main pattern at the corners of the substrate.

### CLAIM OF PRIORITY

This application makes reference to, incorporates the same herein, and claims all benefits accruing under 35 U.S.C. §119 from an application for SEALANT PATTERN FOR FLAT PANEL DISPLAY AND FPD WITH THE SAME earlier filled in the Korean Intellectual Property Office on 22 Nov. 2004 and there duly assigned Ser. No. 10-2004-0095942.

### BACKGROUND OF THE INVENTION

1. Field of the Invention

The present invention relates to a flat display panel, and more particularly, to a sealant having protrusion parts on comers of a substrate and an Organic Light Emitting Diode (OLED) using the sealant.

2. Description of the Related Art

Light emitting diodes are classified into inorganic Light Emitting Diodes (LEDs) and Organic Light Emitting Diodes (OLEDs) according to the kind of light emitting compound used to form an organic film layer between an anode electrode and a cathode electrode. Inorganic LEDs have a long lifetime, but have low light emission efficiency and a high driving voltage. On the other hand, OLEDs have high light emitting efficiency and a low driving voltage, but have a short lifetime.

An OLED includes anode electrodes arranged in one direction, cathode electrodes arranged to cross the anode electrodes, and organic light emitting layers interposed between the anode electrodes and the cathode electrodes on a substrate. An OLED is an emissive device, that is, it includes an organic light emitting layer that emits light according to the voltages supplied to the anode electrode and the cathode electrode.

OLEDs are widely used since they have a high resolution and a high impact resistance, and can realize a full color image. However, after a prolonged period of driving, OLEDs not only suffer from severe degradation of light emission characteristics, such as brightness and uniformity of light, but also have a short lifespan.

One of the causes of the degradation of the light emission characteristics and the short lifespan is the separation of the organic film layer from the electrodes due to moisture absorbed by the organic film layer and penetrating into the OLED through a defective portion or an edge of the OLED. The separation of the organic film layer from the electrodes produces dark points which do not emit light.

In the prior art, to prevent the degradation of the characteristics and the reduction of lifespan of an OLED by moisture and air, a substrate on which the OLED is formed, that is, an array substrate, is sealed by a sealing member using a sealant. However, in the case of an OLED in which the substrate is sealed by the sealing member using the sealant, the characteristics are degraded or the lifespan is reduced due to the moisture and oxygen penetrating from the outside or already absorbed in the organic film layer.

In the prior art, to maintain the characteristics and to extend the lifespan of an OLED by preventing defects such as dark points caused by the penetration of moisture and air, a protection film is formed on the entire surface of the substrate on which the OLED is formed or a substrate on which the OLED is sealed by a sealing substrate that includes a moisture absorbing material using a sealant.

Japanese Laid-Open Patent No. 2002-184569 relates to an organic light emitting display device having a sealing structure for preventing the penetration of oxygen and moisture by forming a metal absorption film on the OLED after a substrate, on which the OLED has been formed, is sealed by a sealing substrate using a sealant.

Japanese Laid-Open Patent No. 2002-280169 relates to an organic light emitting display device having an OLED within an inner barrier rib of a frame-type and having an outer barrier rib of a frame-type formed along the inner barrier rib of a frame-type. The reliability of the organic light emitting display device is improved by reducing the penetration of moisture by bonding an upper substrate and a lower substrate using an adhesive filled between the inner barrier rib of a frame-type and the outer barrier rib of a frame-type.

However, in the above-noted organic light emitting display device, the sealant pattern for sealing upper and lower substrates has a frame-type. Therefore, the upper and lower substrates can be easily exfoliated by impacts on the corners of the substrates, thereby reducing the reliability and lifespan of the device. Particularly, in a flexible organic light emitting display device, the separation is severe at the edge portions of the panel due to bending of the substrate.

### SUMMARY OF THE INVENTION

The present invention provides a sealant pattern that can prevent the separation of corners of a substrate by providing protrusion parts on the corners of the substrate and an organic light emitting display device having the sealant pattern.

According to one aspect of the present invention, a flat display device is provided including: a substrate including an image display unit on which display devices are arranged; and a sealing member adapted to seal the substrate with a sealant, the sealant including a main pattern adapted to surround the image display unit and protrusion patterns protruding from the main pattern at corners of the substrate.

The main pattern of the sealant preferably includes a frame pattern. The main pattern of the sealant preferably includes angled or rounded corners.

The protrusion parts of the sealant preferably include at least one bar pattern shaped part protruding from the main pattern at one corner of the substrate. The protrusion parts of the sealant preferably include at least one block pattern shaped part protruding from the main pattern at one corner of the substrate. The protruded pattern shaped part preferably includes a rectangular or circular shape.

The flat display device preferably further includes an organic light emitting display device.

The sealant is preferably selected from the group consisting of a thermosetting resin, an ultraviolet setting resin, and a thermoplastic resin.

The flat display device preferably further includes a flexible display device including a flexible substrate as the substrate and the sealing member.

According to another aspect of the present invention, a sealant for a flat display device includes a substrate having an image display unit on which display devices are arranged, and a sealing member adapted to seal the substrate with the sealant, the sealant including: a main pattern adapted to surround the image display unit along edges of the substrate; and protrusion parts protruding from the main pattern at corners of the substrate.

The main pattern of the sealant preferably includes a frame pattern. The main pattern of the sealant preferably includes angled or rounded corners.

The protrusion parts of the sealant preferably include at least one bar shape protruding from one corner of the substrate. The protrusion parts of the sealant preferably include at least one block pattern shaped part protruding from the main pattern at one corner of the substrate.

The protruded pattern shaped part preferably includes a rectangular or circular shape.

The sealant preferably includes a resin selected from the group consisting of a thermosetting resin, an ultraviolet setting resin, and a thermoplastic resin.

The flat display device preferably includes an organic light emitting display device. The flat display device preferably includes a flexible display device including a flexible substrate as the substrate and the sealing member.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a plan view of an organic light emitting display device according to an embodiment of the present invention;

FIG. 2 is a cross-sectional view taken along line II-II of FIG. 1; and

FIG. 3 is a plan view of an organic light emitting display device according to another embodiment of the present invention.

### DETAILED DESCRIPTION OF THE INVENTION

The present invention is described more fully below with reference to the accompanying drawings in which exemplary embodiments of the invention are shown.

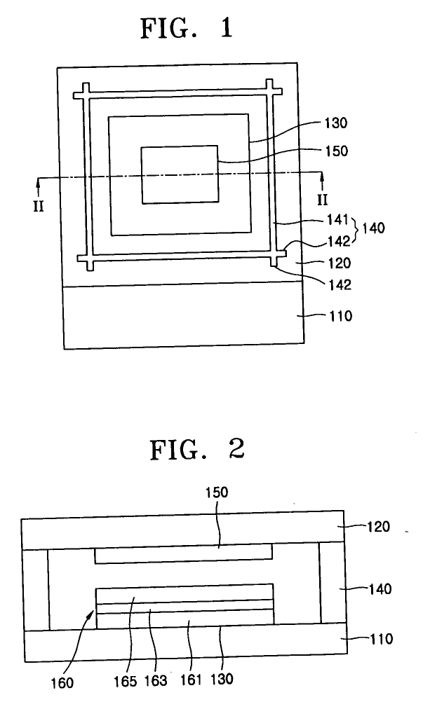

FIG. 1 is a plan view of an organic light emitting display device according to an embodiment of the present invention.

Referring to FIG. 1, an organic light emitting display device according to an embodiment of the present invention includes a substrate 110 having an image display unit 130. Organic Light Emitting Diodes (OLEDs) are arranged on the image display unit 130 of the substrate 110. The substrate 110 can be a glass substrate or a flexible substrate. The organic light emitting display device includes a flexible display device that uses a flexible substrate as the substrate 110.

The flexible substrate can be formed of a polymer plastic film, and is preferably formed of a film having high heat resistance to withstand the temperatures used in manufacturing the display device. The flexible substrate can be formed of polyethersulphone (PES), polyacrylate (PAR), polyetherimide (PEI), polyethylene napthalate (PEN), polyethylene terephthalate (PET).

The OLEDs arranged on the substrate 110 are sealed by a sealing member 120. The sealing member 120 includes a glass substrate, a metal cap, or a synthetic resin film. Also, the sealing member 120 can include a flexible substrate like the substrate 110.

The sealing member 120 includes an absorbent 150 for absorbing moisture or oxygen contained in the air between the substrate 110 and the sealing member 120. The absorbent 150 can include silica, synthetic zeolite, P₂O₅, or BaO, or can include an absorbent that hardens by heat or ultraviolet rays.

The substrate 110 and the sealing member 120 are bonded by a sealant 140. The sealant 140 includes a main pattern 141 having a frame shape that surrounds the image display unit 130 along the edges of the substrate 110 or the sealing member 120 and protrusion parts 142 having a bar shape protruding from the corners of the main pattern 141. The main pattern 141 can have an angled corner frame shape or a rounded corner frame shape. The size of the protrusion part 142 is determined by the size of a region on which the sealant 140 is coated and is a few hundred micrometers.

The sealant 140 can include a thermosetting resin, an ultraviolet ray setting resin, and a thermoplastic resin. The thermosetting sealant can include resins of phenols, epoxies, polyurethanes, and polyesters.

In the present embodiment, the main pattern 141 of the sealant 140 has a frame shape surrounding the image display unit 130 along the edges of the substrate 110 or the sealing member 120. However, the present invention is not limited thereto. That is, the main pattern 141 of the sealant 140 can be arranged in any form along the edges of the substrate 110 or the sealing member 120.

Also, in the present embodiment, the protrusion part 142 includes two bar patterns protruding from the corners of the main pattern 141 and the protrusion part 142 has the same width of the main pattern 141. However, the present invention is not limited thereto. The protrusion part 142 can include at least one bar pattern protruding from the corners of the main pattern 141, and the width of the bar pattern can vary independently of the width of the main pattern 141.

FIG. 2 is a cross-sectional view taken along line II-II of FIG. 1. Referring to FIG. 2, in the organic light emitting display device according to the present invention, OLEDs 160 are arranged in the image display unit 130 of the substrate 110. The OLEDs 160 includes a lower electrode 161, an organic thin film layer 163, and an upper electrode 165. The organic thin film layer 163 includes at least one organic film selected from among a hole injection layer, a hole transport layer, a light emitting layer, an electron transport layer, an electron injection layer, and a hole blocking layer. The lower electrode 161 and the upper electrode 165 include a transparent electrode or an non-transparent electrode according to the direction of light emitted from the light emitting layer.

If the organic light emitting display device is an active matrix type, a thin film transistor (not shown) for driving the organic light emitting diode can also be included.

The organic light emitting display device, to which the present embodiment is applied, is not limited to the structure of the organic light emitting display device depicted in FIG. 2. Rather, the present embodiment can be applied to organic light emitting display devices having various structures.

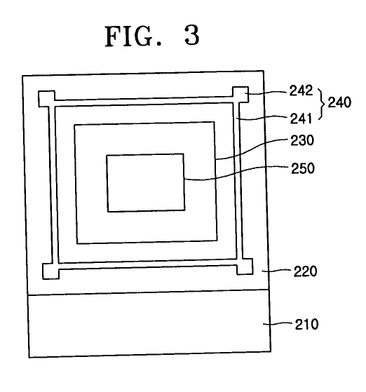

FIG. 3 is a plan view of an organic light emitting display device according to another embodiment of the present invention.

Referring to FIG. 3, an organic light emitting display device according to an embodiment of the present invention includes a substrate 210 having an image display unit 230 and a sealing member 220 for sealing the image display unit 230 of the substrate 210. As depicted in FIG. 2, OLEDs are arranged in the image display unit 230 of the substrate 210.

The substrate 210 can be a glass substrate or a flexible substrate. The flexible substrate can be formed of polyethersulphone (PES), polyacrylate (PAR), polyetherimide (PEI), polyethylene napthalate (PEN), polyethylene terephthalate (PET).

The sealing member 220 can be a glass substrate, a metal cap, or a synthetic resin film. The sealing member 220 includes an absorbent 250 for absorbing moisture or oxygen contained in the air between the substrate 210 and the sealing member 220. The absorbent 250 can include silica, synthetic zeolite, P₂O₅, or BaO, or can include an absorbent that hardens by heat or ultraviolet rays.

The substrate 210 and the sealing member 220 are bonded by a sealant 240. The sealant 240 includes a main pattern 241 having a frame shape that surrounds the image display unit 230 along the edges of the substrate 210 or the sealing member 220 and protrusion parts 242 having a block shape protruding from the corners of the main pattern 241. The main pattern 241 can have an angled corner frame shape or a rounded corner frame shape. The protrusion part 242 can be formed in a rectangular shape or a circle shape. The size of the protrusion part 242 is determined by the size of a region on which the sealant 240 is coated and is a few hundred micrometers.

The sealant 240 can include a thermosetting resin, an ultraviolet ray setting resin, and a thermoplastic resin. The thermosetting sealant can include resins of phenols, epoxies, polyurethanes, and polyesters.

In another embodiment of the present invention, the main pattern 241 of the sealant 240 has a frame shape surrounding the image display unit 230 along the edges of the substrate 210 or the sealing member 220. However, the present invention is not limited thereto. That is, the main pattern 241 of the sealant 240 can be arranged in any form along the edges of the substrate 210 or the sealing member 220.

Also, the protrusion part 242 has a pattern having a block shape protruding from the corners of the main pattern 241. However, the present invention is not limited thereto. The protrusion part 242 can have any shape protruding from the corners of the main pattern 241.

The organic light emitting display device according to another embodiment of the present invention has a cross-sectional structure as depicted in FIG. 2.

Also, in the present embodiment, a sealant pattern is proposed in the organic light emitting display device for sealing the substrate, on which light emitting diodes such as the OLEDs are arranged, using a sealing member. However, the present invention is not limited thereto. The present invention can also be applied to any flat display devices, such as a liquid crystal display device.

In the present embodiments, the bonding force between the upper and lower substrates is increased by including protrusion parts of the sealant at the corners of the substrate. However, the present invention is not limited thereto. That is, the protrusion parts can be included at the sides of the substrate.

As described above, the organic light emitting display device according to the present embodiments increases the bonding force between the substrate and the sealing member by including protrusion parts of the sealant at the corners of the substrate and prevents the separation of the substrate at the corners. Accordingly, the reliability and lifespan of the organic light emitting display device can be improved since defects, such as dark points, due to the penetration of oxygen or moisture, can be prevented.

Also, when applied to a flexible organic light emitting display device, the organic light emitting diode can be protected from separation of panel edges due to bending of the substrate, and can provide a sufficient bonding force between the upper and lower substrates of a large display.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A flat display device, comprising:
a substrate including an image display unit on which display devices are arranged; and
a sealing member adapted to seal the substrate with a sealant, the sealant including a main pattern adapted to surround the image display unit and protrusion patterns protruding from the main pattern at corners of the substrate.

2. The flat display device of claim 1, wherein the main pattern of the sealant comprises a frame pattern.

3. The flat display device of claim 2, wherein the main pattern of the sealant comprises angled or rounded corners.

4. The flat display device of claim 1, wherein the protrusion parts of the sealant comprise at least one bar pattern shaped part protruding from the main pattern at one corner of the substrate.

5. The flat display device of claim 1, wherein the protrusion parts of the sealant comprise at least one block pattern shaped part protruding from the main pattern at one corner of the substrate.

6. The flat display device of claim 5, wherein the protruded pattern shaped part comprises a rectangular or circular shape.

7. The flat display device of claim 1, further comprising an organic light emitting display device.

8. The flat display device of claim 1, wherein the sealant is selected from the group consisting of a thermosetting resin, an ultraviolet setting resin, and a thermoplastic resin.

9. The flat display device of claim 1, further comprising a flexible display device including a flexible substrate as the substrate and the sealing member.

10. A sealant for a flat display device including a substrate having an image display unit on which display devices are arranged, and a sealing member adapted to seal the substrate with the sealant, the sealant comprising:
a main pattern adapted to surround the image display unit along edges of the substrate; and
protrusion parts protruding from the main pattern at corners of the substrate.

11. The sealant of claim 10, wherein the main pattern of the sealant comprises a frame pattern.

12. The sealant of claim 10, wherein the main pattern of the sealant comprises angled or rounded corners.

13. The sealant of claim 10, wherein the protrusion parts of the sealant comprise at least one bar shape protruding from one corner of the substrate.

14. The sealant of claim 10, wherein the protrusion parts of the sealant comprise at least one block pattern shaped part protruding from the main pattern at one corner of the substrate.

15. The sealant of claim 14, wherein the protruded pattern shaped part comprises a rectangular or circular shape.

16. The sealant of claim 10, comprising a resin selected from the group consisting of a thermosetting resin, an ultraviolet setting resin, and a thermoplastic resin.

17. The sealant of claim 10, wherein the flat display device comprises an organic light emitting display device.

18. The sealant of claim 10, wherein the flat display device comprises a flexible display device including a flexible substrate as the substrate and the sealing member.
